(19) United States
(12) Patent Application Publication
(10) Pub. No.: US 2023/0404067 A1
(43) Pub. Date: Dec. 21, 2023

(54) METHOD AND APPARATUS FOR REDUCING PROBABILITY OF ICE NUCLEATION DURING PRESERVATION OF BIOLOGICAL MATTER IN ISOCHORIC SYSTEMS

(71) Applicant: BioChoric, Inc., Bozeman, MT (US)

(72) Inventors: Boris Rubinsky, El Cerrito, CA (US); Matthew Powell-Palm, Bozeman, MT (US)

(21) Appl. No.: 18/208,576

(22) Filed: Jun. 12, 2023

Related U.S. Application Data
(60) Provisional application No. 63/351,825, filed on Jun. 14, 2022.

(51) Int. Cl. A01N 1/02

(52) U.S. Cl. CPC A01N 1/0284; A01N 1/0221

(57) ABSTRACT

A method for reducing probability of ice nucleation during preservation of biological matter in isochoric systems by placing biological matter in a flexible, impermeable inner container, adding an inner solution with a melting point that is higher than a desired storage temperature, removing bulk gas from and sealing the inner container, placing the inner container in a rigid, non-thermally insulating outer container, filling the space between the inner and outer containers with an outer solution, removing bulk gas from and sealing the outer container, cooling the system to the desired storage temperature, maintaining the desired storage temperature for a desired storage period, warming the system to a temperature that is higher than the desired storage temperature, unsealing the outer and inner containers, and removing the biological matter. The outer solution has a melting point that is lower than the equilibrium melting point of the biological matter and the inner solution.

### CROSS-REFERENCE TO RELATED APPLICATION

Pursuant to 35 U.S.C, § 119(e), this application claims the benefit of U.S. Patent 63/351,825, filed on Jun. 14, 2022, the contents of which are incorporated herein by reference.

### BACKGROUND OF THE INVENTION

### 1. Field of the Invention

The present invention relates generally to methods and systems for preserving biological matter, and more particularly, to a method and apparatus for preserving unfrozen biological matter at subzero Centigrade temperatures by reducing the probability of ice nucleation in isochoric supercooling preservation or isochoric vitrification preservation.

### 2. Description of the Related Art

Preservation of biological matter such as molecules, cells, complex organs or organisms, tissues, or foods is essential to current medical and research applications, and to the food and pharmaceutical industry (1-3). Life processes are temperature-dependent chemical reactions, and the time of preservation of biological matter can be extended by preserving the matter at increasingly low temperatures. Conventional sub-normothermic preservation across a wide range of biological matter is performed at or around 4° C.

Although preservation at even lower temperatures could further extend the period of preservation, this further extension is often hindered by the formation of ice at subzero Centigrade temperatures, which yields chemical and mechanical effects that prove detrimental to the biological matter.

The present invention is designed to reduce the probability of ice nucleation during two forms of sub-0° C. preservation of biological matter: isochoric vitrification and isochoric supercooling. These two techniques are discussed more fully below.

### A. Vitrification

Cryopreservation of biological matter by vitrification has been known since the early 20^{th} century (4). The basic principle of preservation by vitrification is to bring biological matter to cryogenic temperatures without the formation of ice, such that the water interior to the biologic becomes a glass, i.e., a liquid with so high a viscosity that the formation of ice becomes improbable on a time scale of years. The success of the vitrification process is contingent on avoiding ice nucleation first during the process of cooling the biological matter to below its glass transition temperature, or the temperature at which its viscosity reaches 10¹³ poise or higher, and again upon re-warming it. The probability of ice nucleation in any system is a function of system chemistry or solute concentration (higher concentrations make nucleation less likely), system viscosity (higher viscosities make nucleation less likely), system volume (higher volumes make nucleation more likely), and the number and potency of heterogeneous nucleation sites within the system (more heterogeneous nucleation sites make nucleation more likely). The process of vitrification is also an inherently metastable thermodynamic process, meaning that ice nucleation is not thermodynamically impossible in the vitrified state, but instead highly improbable. Given this metastability, new techniques for preservation of biological matter by vitrification are developed with the aim of reducing the probability for ice nucleation during the vitrification process.

The basic principles of preservation of biological matter by vitrification are described in (5) (6). Successful vitrification of embryos was reported in (7). Attempts at vitrifying larger volumes of tissue have also been reported (8). The drawbacks of biological matter preservation by vitrification include: the technical difficulties of introducing the high concentrations of chemical additives typically required to avoid ice nucleation into the biological matter; the biological toxicity of these additives; and the technical difficulties in removing these additives after preservation. At the concentrations required for unconditionally successful vitrification, i.e., vitrification that is not dependent on cooling rates or other processing parameters, the chemical additives can be both severely toxic and difficult to perfuse into large biological matter. Although preservation of single cells by vitrification has now become routine, preservation of a large-volume organ has not yet been accomplished.

Several patents are directed to the use of vitrification for biological matter preservation. One example is U.S. Pat. No. 4,559,298 (Fahy, 1985), which provides “a method for the successful cryopreservation of biological materials including whole organs, organ sections, tissues and cells, in a non-frozen (vitreous) state, comprising cooling the biological material to be preserved under pressure in the presence of a non-toxic vitrifiable protective solution to at least the glass transition temperature thereof to vitrify the solution without substantial nucleation or ice crystal growth and without significant injury to the biomaterial. The invention also provides non-toxic protective vitrification solutions useful in the cryopreservation of biomaterials.” Attempts to improve vitrification have focused primarily on developing new compositions of solutions that, when introduced into biological matter, facilitate vitrification at lower concentrations and lower toxicity.

Recently, a new technology called “isochoric vitrification” was introduced. This technology appears to facilitate vitrification at lower concentrations and/or lower cooling and warming rates. In isochoric vitrification, the biological matter and a surrounding solution that is in osmotic equilibrium with the biological matter are confined in a rigid chamber, absent large amounts of air. In U.S. Patent Application Pub. No. 20200178518 (Rubinsky et al.), the inventors explain that (i) by monitoring the temperature and pressure of the interior of the chamber, it is possible to determine whether a given solution undergoes vitrification and (ii) this monitoring may be used to ensure successful vitrification of biological matter within the chamber.

### B. Supercooling

Supercooling is another method of cryopreservation intended to avoid ice formation, which is used for storage at temperatures above the glass transition temperature of the biological matter. The term “supercooling” broadly describes the process by which an aqueous solution can be in a metastable liquid state at temperatures lower than the thermodynamic melting temperature of that solution. Similar to vitrification, the metastability of supercooling implies that there is always some probability of ice nucleation, which, at temperatures in the conventional range of 0° C. to −20° C., can typically be avoided on the timescale of days to months. Ice nucleation in a supercooled system is influenced by a number of factors. The general likelihood of nucleation is affected by the same factors that affect vitrification (system chemistry, system viscosity, system volume, heterogeneous nucleation sites). Additionally, ice nucleation may be directly initiated in supercooled systems by mechanical or vibrational stimulation, ultrasonic stimulation, fluid-fluid interface instabilities, heterogeneous interaction with solid surfaces or gaseous interfaces, and cavitation of gas bubbles within the liquid. Nevertheless, preservation of biological matter by supercooling has been reported and successfully used (9).

Attempts to reduce the probability of ice formation in supercooled systems have led to the development of a variety of methods. Because the probability for nucleation is a direct function of the volume of water in the system, one method aims to reduce the volume of water inside cells (10). Another method aims to use electromagnetic fields to reduce the probability for nucleation (11). Antifreeze proteins have also been used to this end (12), (13), (14-16).

Another method for supercooling involves eliminating the interface between the liquid storage solution and air, using with an immiscible liquid phase. The air-solution interface of the solution containing the biological material is covered with hydrocarbon-based oils such as mineral oil, olive oil or paraffin oil, or alcohols and alkanes, all of which reduce the probability for heterogeneous (or surface-based) ice formation at the air/solution interface (17). A further method for reducing the probability of ice formation in biological matter in a supercooled state involves confining the matter and any accompanying storage solution in a rigid, air-tight isochoric chamber. The benefits of preservation by isochoric supercooling extend to applications involving both heterogeneous and homogeneous (volume-based) ice nucleation (18) (19).

Several patents and patent applications that aim to increase the stability of water in a supercooled metastable state (i.e., reduce the probability of ice formation) aim to reduce heterogeneous ice nucleation by removing unfavorable surfaces or interfaces in contact with the biological matter or the accompanying storage solution. For example, as described above, Usta et al. have developed a method of sealing the free surface of supercooled water with an immiscible liquid (such as an oil), which they claim reduces the likelihood of nucleation by removing air as a heterogeneous nucleation site. International Patent Application Pub. No. WO2021158203. Similarly, Aizenberg et al. have developed a variety of porous surface coatings impregnated with hydrophobic liquids (typically perfluorinated substances) in order to reduce heterogeneous ice nucleation on container surfaces. U.S. Pat. No. 9,932,484 (2018). A method to enhance supercooling through the use of magnetic or electric fields is reported in U.S. Pat. No. 10,111,452 (2018) to Jun et al.

The use of isochoric (constant-volume) systems to reduce the probability of homogeneous ice nucleation is reported in U.S. Patent Application Pub. No. 20070042337 (Rubinsky et al.). The use of constant-volume (isochoric) systems to reduce the probability of heterogeneous ice nucleation is reported in International Patent Application No. PCT/US21/12863. Detailed information on isochoric preservation is found in the 2006 University of California, Berkeley, Ph.D. thesis of Pedro Alejandro Perez entitled, “Thermodynamics and Heat Transfer analysis for isochoric cryopreservation” (20).

### C. Objects of the Present Invention

The present invention is directed to a method and an apparatus for reducing the probability of ice nucleation during isochoric preservation. The present invention is relevant to preservation of biological matter by isochoric vitrification and isochoric supercooling. More specifically, the present invention provides a method and an apparatus for reducing the probability of ice nucleation in biological matter in an isochoric system by preserving the biological matter in a vitrified or partially vitrified state at temperatures lower than the glass formation temperature of the biological matter and the solution in which it is kept. The present invention also provides a method and an apparatus for reducing the probability of ice nucleation in biological matter in an isochoric system by preserving it in a supercooled state at temperatures lower than the equilibrium melting point of the biological matter and the solution in which it is kept. In both cases, the present invention reduces the probability of ice nucleation by (1) reducing the liquid volume within the isochoric system that is susceptible to ice nucleation and (2) ensuring that this reduced volume is only in contact with heterogeneous materials or surfaces that are as or less likely to stimulate heterogeneous nucleation than the walls of the isochoric chamber itself.

### BRIEF SUMMARY OF THE INVENTION

The present invention is a method for reducing probability of ice nucleation during preservation of biological matter in isochoric systems comprising: placing biological matter in a flexible and impermeable inner container; adding to the inner container an inner solution with a melting point that is higher than a desired storage temperature; removing bulk gas from the inner container; sealing the inner container; placing the inner container in a rigid, non-thermally insulating outer container so as to create a space between an outer surface of the inner container and an inner surface of the outer container; filling the space between the outer surface of the inner container and the inner surface of the outer container with an outer solution; wherein the biological matter and the inner solution together each has an equilibrium melting point, and the outer solution has a melting point that is lower than the equilibrium melting point of the biological matter and lower than the equilibrium melting point of the inner solution; removing bulk gas from the outer container; sealing the outer container; cooling the inner container, the outer container, the biological matter, the inner solution, and the outer solution to the desired storage temperature; maintaining the inner container, the outer container, the biological matter, the inner solution, and the outer solution at the desired storage temperature for a desired storage period; warming the inner container, the outer container, the biological matter, the inner solution, and the outer solution to a temperature that is higher than the desired storage temperature; unsealing the outer container and the inner container; and removing the biological matter from the inner container.

In an alternate embodiment, the present invention is a method for reducing probability of ice nucleation during preservation of biological matter in isochoric systems comprising: placing biological matter in a flexible and impermeable inner container; removing bulk gas from the inner container; sealing the inner container; placing the inner container in a rigid. non-thermally insulating outer container so as to create a space between an outer surface of the inner container and an inner surface of the outer container; filling the space between the outer surface of the inner container and the inner surface of the outer container with an outer solution; wherein the biological matter has a melting point, and the outer solution has a melting point that is lower than the melting point of the biological matter; removing bulk gas from the outer container; sealing the outer container; cooling the inner container, the outer container, the biological matter, and the outer solution to the desired storage temperature; maintaining the inner container, the outer container, the biological matter, and the outer solution at the desired storage temperature for a desired storage period; warming the inner container, the outer container, the biological matter, and the outer solution to a temperature that is higher than the desired storage temperature; unsealing the outer container and the inner container; and removing the biological matter from the inner container.

In a preferred embodiment, the desired storage temperature is at or less than 0° Celsius. In another preferred embodiment, the desired storage temperature is lower than the equilibrium melting point of the biological matter and lower than the equilibrium melting point of the inner solution, and the desired storage temperature is higher than the melting point of the outer solution. In yet another preferred embodiment, the desired storage temperature is lower than the melting point of the biological matter, and the desired storage temperature is higher than the melting point of the outer solution.

In a preferred embodiment, the biological matter and the inner solution each has a glass transition temperature; the outer solution has a glass transition temperature; the desired storage temperature is below the glass transition temperature of the biological matter and below the glass transition temperature of the inner solution; the desired storage temperature is below the glass transition temperature of the outer solution; and the glass transition temperature of the outer solution is higher than the glass transition temperature of the biological matter and higher than the glass transition temperature of the inner solution. In an alternate embodiment, the biological matter has a glass transition temperature: the outer solution has a glass transition temperature; the desired storage temperature is below the glass transition temperature of the biological matter; the desired storage temperature is below the glass transition temperature of the outer solution; and the glass transition temperature of the outer solution is higher than the glass transition temperature of the biological matter.

The inner container is preferably comprised of a hydrophobic polymeric substance. In one embodiment, the inner solution is comprised of an aqueous solution containing organic molecules at a first concentration. In another embodiment, the inner solution is comprised of an aqueous solution containing chemical cryoprotectants at a first concentration. Preferably, the outer solution is comprised of an aqueous solution containing organic molecules at a second concentration, and the second concentration of organic molecules in the outer solution is higher than the first concentration of organic molecules in the inner solution. Preferably, the outer solution is comprised of an aqueous solution containing chemical cryoprotectants at a second concentration, and the second concentration of chemical cryoprotectants in the outer solution is higher than the first concentration of organic molecules in the inner solution.

The method optionally comprises the additional step of perfusing the biological matter with the inner solution. In one embodiment, the step of cooling the inner container, the outer container, the biological matter, the inner solution, and the outer solution to the desired storage temperature and the step of warming the inner container, the outer container, the biological matter, the inner solution, and the outer solution to a temperature that is higher than the desired storage temperature are both performed at a rate that is within the range of 0.01° C. per minute to 10° C. per minute. In another embodiment, the step of cooling the inner container, the outer container, the biological matter, the inner solution, and the outer solution to the desired storage temperature and the step of warming the inner container, the outer container, the biological matter, the inner solution, and the outer solution to a temperature that is higher than the desired storage temperature are both performed at a rate that is within the range of 1° C. per minute to 1000° C. per minute. In an alternate embodiment, the step of cooling the inner container, the outer container, the biological matter, and the outer solution to the desired storage temperature and the step of warming the inner container. the outer container, the biological matter, and the outer solution to a temperature that is higher than the desired storage temperature are both performed at a rate that is within the range of 0.01° C. per minute to 10° C. per minute. In another alternate embodiment, the step of cooling the inner container, the outer container, the biological matter, and the outer solution to the desired storage temperature and the step of warming the inner container, the outer container, the biological matter, and the outer solution to a temperature that is higher than the desired storage temperature are both performed at a rate that is within the range of 1° C. per minute to 1000° C. per minute.

The inner container may be comprised of a flexible material that is in direct contact with an outer surface of the biological matter and that does not allow transmission of mass. The flexible material may be a tissue adhesive.

The present invention is also an apparatus for reducing probability of ice nucleation during preservation of biological matter in isochoric systems comprising: an outer container that is rigid and non-thermally insulating; wherein the outer container comprises a seal that is configured to provide air- and liquid-tight sealing; an inner container that is situated within the outer container; wherein the inner container is flexible but cannot transmit mass; an inner solution within the inner container; wherein the inner solution has an equilibrium melting point that is above a desired sub-zero centigrade storage temperature; and an outer solution within the outer container and outside of the inner container; wherein the outer solution is comprised of a liquid that has an equilibrium melting point that is below the desired sub-zero centigrade storage temperature. Alternately, the present invention is an apparatus for reducing probability of ice nucleation during preservation of biological matter in isochoric systems comprising: an outer container that is rigid and non-thermally insulating; wherein the outer container comprises a seal that is configured to provide air- and liquid-tight sealing; an inner container that is situated within the outer container; wherein the inner container is flexible but cannot transmit mass; an inner solution within the inner container; wherein the inner solution has an equilibrium melting point that is above a desired sub-zero centigrade storage temperature; and an outer solution within the outer container and outside of the inner container; wherein the outer solution is configured to undergo vitrification at the desired sub-zero centigrade storage temperature.

In an alternate configuration, the present invention is an apparatus for reducing probability of ice nucleation during preservation of biological matter in isochoric systems comprising: an outer container that is rigid and non-thermally insulating; wherein the outer container comprises a seal that is configured to provide air- and liquid-tight sealing; at least two inner containers that are situated within the outer container; wherein the inner containers are flexible but cannot transmit mass; an inner solution within each of the inner containers; wherein the inner solution has an equilibrium melting point that is above a desired sub-zero centigrade storage temperature; and an outer solution within the outer container and outside of the inner containers; wherein the outer solution is comprised of a liquid that has an equilibrium melting point that is below the desired sub-zero centigrade storage temperature. Alternately, the present invention is an apparatus for reducing probability of ice nucleation during preservation of biological matter in isochoric systems comprising: an outer container that is rigid and non-thermally insulating; wherein the outer container comprises a seal that is configured to provide air- and liquid-tight sealing; at least two inner containers that are situated within the outer container; wherein the inner containers are flexible but cannot transmit mass; an inner solution within each of the inner containers; wherein the inner solution has an equilibrium melting point that is above a desired sub-zero centigrade storage temperature; and an outer solution within the outer container and outside of the inner containers; wherein the outer solution is configured to undergo vitrification at the desired sub-zero centigrade storage temperature.

The apparatus of the present invention preferably further comprises: a means of providing temperature control to the apparatus; a means of monitoring temperature of the outer container; a means of monitoring pressure within the outer container; and an external processor that is configured to communicate with the means of providing temperature control, the means of monitoring temperature, and the means of monitoring pressure. In a preferred embodiment, each of the inner containers is comprised of a low-density polyethylene. The outer container is preferably comprised of a transparent rigid material. Preferably, the invention further comprises a means for protecting the apparatus from vibration.

### BRIEF DESCRIPTION OF THE DRAWINGS

FIG. 1 is a flow chart that illustrates the initial steps of a preferred embodiment of the method of the present invention.

FIG. 2 is a flow chart that illustrates the intermediate steps of a preferred embodiment of the method of the present invention.

FIG. 3 is a flow chart that illustrates the final steps of a preferred embodiment of the method of the present invention.

FIG. 4 is a section view schematic illustrating the core components of a preferred embodiment of the apparatus of the present invention.

### DETAILED DESCRIPTION OF INVENTION

### A. Overview

Conventional preservation by isochoric vitrification or isochoric supercooling involves: placing biological matter and a surrounding aqueous solution into a rigid container that transmits heat (i.e., is not designed to provide a thermal barrier) but does not transmit pressure (i.e., is rigid) or mass (i.e., is impermeable); removing excess air from the system; sealing the container such that the system is no longer in contact with the atmosphere or any other reservoir of pressure; and monitoring the temperature and pressure within the chamber. Such rigid containers are commonly used for preservation by isochoric freezing (21), (20), isochoric supercooling (22-24), and isochoric vitrification (25), and the pressure read inside the system for a given temperature indicates whether ice nucleation has occurred (and if so to what degree).

In current methods and devices for preservation by isochoric supercooling or isochoric vitrification, the solution that occupies the entire volume of the rigid isochoric chamber is subject to the probability of nucleation, and this volume may be excessive relative to the volume of the preserved biological matter because the rigid chamber itself is not conformable to the arbitrary shape or shapes of the biological matter stored within.

The present invention aims to reduce the probability of nucleation in isochoric preservation systems by using two containers instead of one—a sealed outer container comprised of a conventional rigid isochoric chamber, and a sealed inner container that cannot transmit mass (i.e., is impermeable) but can transmit pressure (i.e., is flexible)—filled with two solutions possessing a specific thermodynamic relationship to one another. Specifically, the solution in the inner container and/or the biological matter, referred to as the “inner solution,” has a melting point higher than the solution in the space between the outer walls of the inner container and the inner walls of the outer container, referred to as the “outer solution,” and at the desired storage temperature, the inner solution is susceptible to ice nucleation, while the outer solution is not.

The present invention reduces the probability of ice nucleation during isochoric preservation by limiting the volume within the system that is susceptible to ice nucleation and ensuring that that volume is in contact with surfaces that are as likely or less likely to stimulate heterogeneous ice nucleation than the walls of the chamber itself. In relation to preservation by isochoric supercooling, the outer solution is thermodynamically stable in liquid form to the storage temperature or below. In relation to preservation by isochoric vitrification, the outer solution need not be thermodynamically stable, but will not nucleate ice during the process of cooling to or warming from temperatures below the glass transition temperature of the preserved biological matter.

As such, in the present invention, the total volume susceptible to ice nucleation during these isochoric preservation processes is limited to the volume of the inner container alone, reducing the total probability of ice nucleation in the system. Furthermore, because the inner container is not subject to the same requirement of rigidity as the outer container, it can be constructed from any of a wide range of flexible materials that do not provide effective substrates for heterogeneous ice nucleation, such as (but not limited to) generic plastics or polymers derived from hydrocarbons or fluorinated compounds.

### B. Detailed Description of the Figures

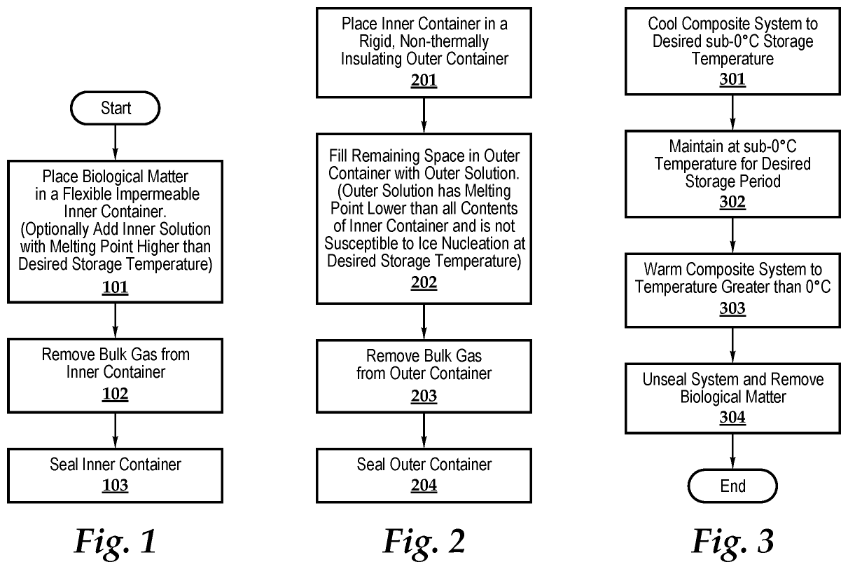

FIG. 1 is a flow chart that illustrates the initial steps of a preferred embodiment of the method of the present invention. First, biological matter with or without a surrounding inner solution of higher melting point than the desired storage temperature is placed into an inner container that can transmit pressure but cannot transmit mass 101. Next, all or most of the bulk gas phase is removed from the inner container 102. Next, the inner container is sealed 103. Preferably, the inner container is constructed of a material known to possess poor heterogeneous ice nucleating ability, such as (but not limited to) polytetrafluoroethylene, polyethylene, or another hydrophobic polymeric substance.

FIG. 2 is a flow chart that illustrates the interim steps of a preferred embodiment of the method of the present invention. After the steps shown in FIG. 1 are completed, the inner container with the biological matter prepared as described above is placed in a rigid outer container that can transmit heat (i.e., is non-thermally insulating) 201. Next, the space between the inner and outer containers is filled with an outer solution that (a) possesses a lower melting point than both the aqueous contents within the biological matter and any inner solution and (b) is not susceptible to ice nucleation at the desired storage temperature 202. Next, all or most bulk gas phase is removed from the outer container 203. Next, the outer container is sealed 204.

FIG. 3 is a flow chart that illustrates the final steps of a preferred embodiment of the method of the present invention. First, the composite system comprised of the sealed inner and outer chambers is cooled to a desired sub-0° C. storage temperature 301. Next, the composite system is maintained at this temperature for a desired storage period 302. Next, the temperature of the composite system is rewarmed to a temperature greater than 0° C. 303. Next, the chamber is unsealed, and the biological matter is removed 304. In some embodiments, when applying this invention to preservation of biological matter by isochoric supercooling. the storage temperature is lower than both the melting point of the aqueous contents within the biological matter and any inner solution and higher than the melting point of the outer solution. In other embodiments, when applying this invention to preservation of biological matter by isochoric vitrification, the storage temperature is below the glass transition temperatures of both the aqueous contents within the biological matter and any inner solution and also below the glass transition temperature of the outer solution.

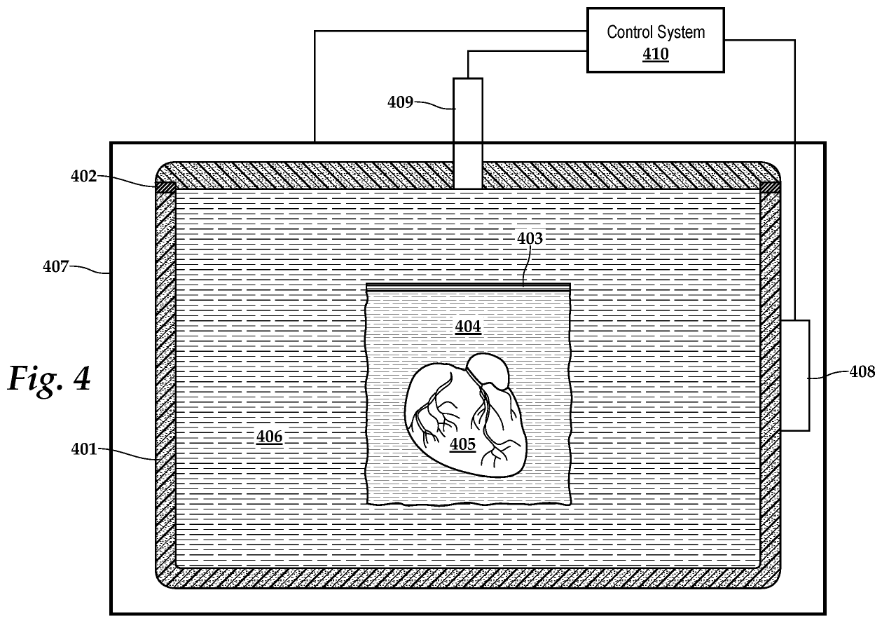

FIG. 4 is a section view schematic illustrating the core components of a preferred embodiment of the apparatus of the present invention. The apparatus comprises: an outer container 401 that is rigid, transmits heat (i.e., is non-thermally insulating), and has a seal 402 that can provide air- and liquid-tight sealing; an inner container 403 within the outer container that can transmit pressure (i.e., is flexible) but cannot transmit mass; an inner solution 404 within the inner container in which biological matter 405 may be stored, and which has an equilibrium melting point above the desired sub-zero centigrade storage temperature, thereby making it susceptible to ice nucleation; a separate outer solution 406 within the outer container and outside of the inner container, comprised of a liquid that may or may not be aqueous in nature, and which either has an equilibrium melting point below the desired sub-zero centigrade storage temperature or will otherwise not undergo a first-order phase change at the same desired storage temperature. The apparatus may also optionally include an external means of providing temperature control and cooling/warming to the system 407, such as a bath of circulating liquid, gas, or vapor, a refrigerator, a phase-change material, a thermoelectric or Peltier module, a Stirling cooler. or a resistance heater; a means of monitoring the temperature of the system 408, such as a thermocouple, resistor, or thermometer; a means of monitoring the pressure within the outer container 409, such as a digital pressure transducer, a pressure gauge, a pressure-sensitive optical port, or a strain gauge; and a control system 410 such as a computer or microprocessor, which is in communication with the means of temperature and/or pressure measurement and the means of temperature control and cooling/warming.

The inner container 403 contains the biological matter 405 to be preserved. In some embodiments of the invention, the inner solution 404 within the inner container 403 is comprised of water or an aqueous solution containing added organic molecules or chemical cryoprotectants. These additives may dictate the range of temperatures to which the system can be supercooled without ice nucleation, or they may increase the stability of supercooling at a given preservation temperature. They may also increase the glass transition temperature of the solution to increase ease of vitrification, reduce the melting or freezing point of the solution, and/or minimize toxicity to the biological matter. Such chemical additives include, but are not limited to, dimethyl sulfoxide, ethylene glycol, polyethylene glycol, 3-OMG, glycerol, antifreeze proteins, ice recrystallization inhibitors, synthetic or organic ice modulators, sugars, sugar alcohols, amino acids, salts, etc.

The outer solution 406 may be comprised of an aqueous solution incorporating these same additives, albeit at higher concentrations that render the outer solution insusceptible to ice nucleation at the desired storage temperatures. For example, aqueous solutions of 49% (mass/mass) dimethylsulfoxide are known to vitrify (i.e., avoid ice formation and form a glass) under arbitrary cooling and warming conditions. These solutions thus present a preferable embodiment of the outer solution 406 in applications for isochoric vitrification. Furthermore, because the inner container 403 housing the biological matter 405 does not transmit mass, the liquid of which the outer solution 406 is comprised need not be aqueous, biocompatible, or minimally toxic. As an example, in an application storing a human organ via isochoric supercooling at a desired storage temperature of −10° C. while the inner solution 404 may be a conventional aqueous organ preservation solution such as Custodiol™, which is susceptible to freezing at temperatures below approximately −0.5° C., the outer solution 406 may be a perfluorocarbon or hydrocarbon liquid with a melting point less than −10° C.

By way of illustration but not limitation, the biological matter 405 may be comprised of human or non-human cells, organic molecules, multicellular constructs, tissues, organs, full organisms and/or food(s), including but not limited to stem cells, blood, bone marrow, blood vessels, pancreatic islets, reproductive tissues, skin, etc; hearts, livers, kidneys, lungs, pancreases, spleens, etc.; eyes, full or partial limbs, fingers or toes, brains, spinal columns, dorsal ganglia, nervous tissue, etc.; engineered tissues such as 3D microtissue constructs, liver-on-a-chip constructs, lung-on-a-chip constructs, heart-on-a-chip constructs, etc.; full organisms such as zebrafish, coral, nematodes, or other marine or land-dwelling animals; and/or foodstuffs such as cherries, berries, potatoes, tomatoes, fish, beef, etc.

The biological matter 405 may be perfused with or in the inner solution 404 prior to preservation. The biological matter may also undergo some manner of conditioning prior to preservation, including, but not limited to, normothermic or hypothermic machine perfusion, passive or active perfusion with a liquid, or immersion in a liquid of any kind.

In some embodiments, multiple separate and/or different inner containers 403, with separate and/or different inner solutions 404 and separate and/or different biological matter 405, are housed in the outer container 401. Each inner container and inner solution are subject to the same requirements and thermodynamic relationship to the outer solution as described for a single inner container.

The outer container 401 and all contents within it may be stored for any amount of time at one or multiple temperatures between 0° C. and −273° C. 302 and may be cooled 301 and/or warmed 303 at any rate. In some embodiments, when the biological matter 405 to be stored is a human organ, an isochoric supercooling approach may be used, for which the desired storage temperature may be in the range 0° C. to −20° C. to ensure avoidance of nucleation from the supercooled state, and the desired cooling and warming rates may be between 0.01° C./min and 10° C./min so as to not avoid damage from excessively fast temperature change. In other embodiments. when the biological matter 405 to be stored is cells, reproductive matter such as sperm, oocytes, or embyros, or organisms such as coral, an isochoric vitrification approach may be used. for which the desired storage temperature may be in the range of −80° C. to −196° C. to facilitate the glass transition process, and the desired cooling and warming rates may be between 1° C./min and 1000° C./min to ensure avoidance of ice nucleation during the vitrification process.

In the preferred embodiment of the apparatus shown in FIG. 4, the outer container 401 is cooled by a cooling and/or warming system 407 external to the outer container; however, an internal cooling and/or warming system may also be used, examples of which include internal heat exchanger pipes or internal phase-change materials. In all cases, the cooling and/or warming system 407 that modulates the temperature of the outer container 401 may be active (i.e., requiring an input of thermodynamic work), as in a refrigerator or circulating bath, or passive (i.e., proceeding spontaneously), as in a phase change material such as ice or a eutectic salt.

The outer container 401 may be instrumented with an implement to measure or infer the pressure within 409, such as a pressure transducer, a pressure gauge, a pressure-sensitive optical port, or a strain gage. This implement can be used to monitor the pressure either continuously or at discrete points in the process of cooling 301, storage 302, or warming 303. An increase in pressure may be used to determine that ice has nucleated in the system, and the control system 410 communicating with the means of temperature control 407 and the pressure measurement implement 409 may enact changes in temperature based on such a reading from the pressure measurement implement. For example, when the biological matter 405 within the apparatus is a human heart intended for transplantation, and this heart is being stored 302 at a temperature of −4° C., if an increase in pressure were detected (indicating ice nucleation in a sealed system), the control system 410 may issue a command to the temperature control implement 407 to immediately warm the system 303. The control system 410 may also be used to change or adjust the temperature of the system in response to any changes in the measured or inferred pressure within the system because in isochoric systems, the temperatures and pressure are coupled.

The outer 401 or inner 403 containers may feature additional measures to protect the liquid(s) within from vibration, including a sleeve, coating, mount, or other external feature made of a vibration-reducing material such as neoprene or other rubbers; springs or other mechanical features for vibration reduction; and/or combinations thereof. Vibration, which may be encountered during flight, ground-transport, or general use, can cause unwanted ice nucleation.

Ice nucleation can also be stimulated by undesired or uncontrolled changes in temperature, which can also negatively affect stored biological matter 405. The outer 401 and/or inner 403 container(s) may thus feature additional measures to protect the stored supercooled or vitrified biological matter 405 from undesired temperature changes, including a thermally insulating sheath, sleeve, or coating; a surrounding phase-change material; a vacuum-insulated panel, material, or chamber; and/or other thermal insulation measures. Furthermore, the inner container 403 may also feature additional measures to protect specifically against heterogeneous ice nucleation at the solid-liquid interface between the inner container 403 and the inner solution 404, including, but not limited to, hydrophobic or superhydrophobic surfaces or surface coatings, examples of which include polytetrafluoroethylene-based, hydrocarbon-based, and/or perfluorocarbon-based substances.

The outer 401 and inner 403 containers may each contain any volume, and a wide range of volumes may be desired based on the biological matter 405 to be stored. For example, to preserve mesenchymal stem cells by isochoric vitrification, both containers may contain volumes in the 1 microliter to 10 mL range. By contrast, to preserve a human liver by isochoric supercooling, these containers may contain volumes in the 1 L-20 L range. Furthermore, for high-throughput storage of small biological matter such as cell suspensions or engineered tissues, a large outer container 401 on the scale of 1-10 L may be paired with hundreds or thousands of smaller inner containers on the scale of 1-10 mL. In bulk agricultural applications, especially those intended for preservation of food during shipping, outer containers on the scale of 20-1000 L may also be desired.

The outer container 401 may be fabricated from one or multiple suitable rigid materials. These may include metals such as steel and alloys thereof, aluminum and alloys thereof, titanium and alloys thereof, copper and alloys thereof, etc.; ceramic materials; plastics such as acrylic, polyvinyl chloride, polymethylmethacrylate, polyurethane, etc.; composites such as carbon fiber reinforced polymers (CFRP) or glass fiber reinforced polymers (GFRP); and/or any combination thereof. These materials may also be subjected to one or multiple surface treatments, such as anodizing, nickel-plating, zinc-plating, etc. for the purposes of preventing corrosion, preventing heterogeneous ice nucleation, maintaining biocompatibility, etc. The choice of material and surface coating, like many other aspects of the present invention, are a function of the biological matter 405 to be stored and the intended application.

The outer container 401 may also be made in full or in part of a transparent rigid material such as polycarbonate or sapphire, which may be used to study or monitor the internal contents or behaviors of the container during cooling 301, storage 302, or warming 303 of the system, including, but not limited to, the behavior of preserved biologics or of any phase transitions that may occur. In some embodiments, a fully or partially transparent outer container is integrated into a microscope platform, allowing microscopic examination of the contents contained therein. The container may also be constructed in geometries at the millimeter- or micron-length scale for these purposes.

The inner container 403 may be comprised in full or in part of a material or materials that transfer pressure but not mass, such as low-density polyethylene (LDPE). In some embodiments, the inner container 403, which stores the biological matter 405, may be comprised of a bag, balloon, vial or tube covered by a flexible material and/or another vessel that is sealable and includes at least one flexible surface capable of transmitting pressure from its surroundings to its internal contents.

The seal 402 that enables air-tight sealing of the outer container 401 may include one or multiple sealing mechanisms, some of which may include rubber O-rings, spring energized O-rings, metal-on-metal contact, rubber gaskets, metal gaskets, etc. The inner container 403 may optionally be scaled by a single or multiple ridge closure(s), similar to a Ziploc™ bag (U.S. Pat. No. 7,137,736: Closure Device for a Re-closable Pouch), or by a threaded cap, a threaded plug, a clamped lid, a bolted lid, a mechanically retained plate or plug, a pressed film, a knot, and/or another sealing mechanism. The inner container may also be comprised of one or multiple vacuum-sealed bags and/or heat-sealed bags.

In the case that no discrete inner solution 404 surrounds the biological matter 405, the inner container 403 may be comprised of a flexible material in direct contact with the surface of the biological matter that does not allow transmission of mass. This container may be comprised of a coating of petrolatum and/or a coating of a cross-linked hydrogel, such as sodium alginate or hyaluronic acid cross-linked with calcium or other ionic, oxidative, or covalent cross-linkers. This coating itself is impregnated with an organ preservation solution or any other manner of aqueous solution in the interest of maintaining osmotic balance, delivering drugs, enhancing anti-freezing effects, etc. The inner container may also be comprised of tissue adhesives, examples of which include fibrin glues, cyanoacrylates, and urethane prepolymers. Applications of adhesives to biological tissue range from soft (connective) tissue adhesion to hard (calcified) tissue adhesion. They can be in the form of a liquid, paste or thin films. A list of such adhesives is found in Bhagat et al. (26).

### C. Example

In order to prove the concept of the present invention, an apparatus was produced according to the general design of FIG. 4 and tested in preservation of biological matter by isochoric supercooling. A comprehensive description of the results, methods, and apparatus employed in this study are presented in detail in reference (27).

In this example, the preserved biological matter was a pig liver, which was stored successfully for 48 hours at −2° C. without ice nucleation, via the general method of FIGS. 1-3. After rewarming and removal from the chamber, the liver was evaluated by a qualified surgeon and found to be healthy. Histological samples were also taken, which also demonstrated the structural health of the preserved tissue.

In these successful trials, the outer container was comprised of a cylindrical stainless steel vessel with an internal diameter of 300 mm and an internal height of 150 mm, sealed via rubber O-rings. The inner container, in which the liver was stored, was comprised of a flexible hydrophobic low-density polyethylene bag, sealed using heat sealing and reinforced with plastic clamps.

The outer solution was comprised of a 3 molar NaCl solution, which possesses an equilibrium melting point well below the desired storage temperature of −2° C. and was thus not susceptible to ice nucleation. The inner solution was comprised of Custodiol™, a physiological saline solution with an approximately 300 mM osmolality used as a clinical standard in the preservation of livers and other internal organs for transplants. The equilibrium melting point of Custodiol™ is approximately −0.5° C., and it was thus held in a supercooled state at the storage temperature, susceptible to ice nucleation.

The outer container was also instrumented with a thermocouple to continuously monitor temperature and a digital pressure transducer to continuously monitor pressure. An increase in pressure within a sealed isochoric system indicates the nucleation and expansion of ice, and thus the pressure readout was used to continuously evaluate the state of the system, i.e., to verify that ice nucleation had not occurred. Using this apparatus and the general method of FIGS. 1-3, no ice nucleation occurred during any of the trials, yielding healthily preserved livers.

In order to isolate the beneficial effect of the method disclosed herein, in additional trials, the outer container was filled entirely with physiological saline, and the liver was placed directly into this container, without use of a separate inner container and solution. This approach, which is the conventional approach disclosed previously in the literature and prior patent art surrounding isochoric preservation of biological matter, maximizes the probability of deleterious ice nucleation in the system. Predictably. in all trials, this approach led to ice nucleation and freezing of the liver, damaging it irreversibly.

### REFERENCES

1. S. Giwa, et al., The promise of organ and tissue preservation to transform medicine. Nat. Biotechnol. 35, 530-542 (2017).
2. M. J. Taylor, B. P. Weegman, S. C. Baicu, S. E. Giwa, New Approaches to Cryopreservation of Cells, Tissues, and Organs. Transfus. Med. Hemotherapy 46, 197-215 (2019).
3. J. K. Lewis, et al., The Grand Challenges of Organ Banking: Proceedings from the first global summit on complex tissue cryopreservation. Cryobiology 72, 169-182 (2016).
4. B. J. Luyet, E. L. Hodapp. Revival of frog's spermatozoa vitrified in liquid air. Proc. Soc. Exp. Biol. Med. 39, 433-434 (1938).
5. G. M. Fahy, D. R. MacFarlane, C. A. Angell, H. T. Meryman, Vitrification as an approach to cryopreservation. Cryobiology 21, 407-26 (1984).
6. G. M. Fahy, et al., Cryopreservation of organs by vitrification: Perspectives and recent advances in Cryobiology, (2004), pp. 157-178.
7. W. F. Rall, G. M. Fahy, Ice-free cryopreservation of mouse embryos at −196 C, by vitrification. Nature 313, 573-575 (1985).
8. G. M. Fahy, et al., Physical and biological aspects of renal vitrification. Organogenesis 5, 167-175 (2009).
9. E. P. M. A. D. Beljakov, N. A. Rojdestvenskaja, Comparative study of conserved blood stored at a temperature below 0° C. in a liquid supercooling state and in a frozen state. Bibl. Haematol 38, 336-338 (1969).
10. J. Heyman, Y; Xuan, N B; Renard, Preservation in the supercooled state of one-cell rabbit eggs with reduced cell water content. Cryobiology 25, 564-564 (1988).
11. R. Monzen, K; Hosoda, T: Nagai, R; Monzen, Koshiro; Hosoda, Toru; Hayashi, Doubun; Imai, Yasushi; Okawa, Yasuhiro; Kohro, Takahide; Uozaki, Hiroshi; Nishiyama, Tomoki; Fukayama, Masashi; Nagai. The use of a supercooling refrigerator improves the preservation of organ grafts. Biochem. Biophys. Res. Commun. 337, 534-539 (2005).
12. N. Ishine, B. Rubinsky, C. Y. Lee, A histological analysis of liver injury in freezing storage. Cryobiology 39, 271-277 (1999).
13. N. Ishine, B. Rubinsky, C. Y. Lee, Transplantation of mammalian livers following freezing: Vascular damage and functional recovery. Cryobiology 40, 84-89 (2000).
14. G. Amir, et al., Improved viability and reduced apoptosis in sub-zero 21-hour preservation of transplanted rat hearts using anti-freeze proteins. J. Hear. Lung Transplant. 24, 1915-1929 (2005).
15. G. Amir, et al., Prolonged 24-hour subzero preservation of heterotopically transplanted rat hearts using antifreeze proteins derived from arctic fish. Ann. Thorac. Surg. (2004) https:/doi.org/10.1016/j.athoracsur.2003.04.004.
16. G. Amir, et al., Subzero nonfreezing cryopresevation of rat hearts using antifreeze protein I and antifreeze protein III. Cryobiology (2004) https:/doi.org/10.1016/j.cryobiol.2004.02.009.
17. H. Huang, M. L. Yarmush. O. B. Usta, Long-term deep-supercooling of large-volume water and red cell suspensions via surface sealing with immiscible liquids. Nat. Commun. (2018) https:/doi.org/10.1038/s41467-018-05636-0.
18. S. A. Szobota, B. Rubinsky, Analysis of isochoric subcooling. Cryobiology (2006) https:/doi.org/10.1016/j.cryobiol.2006.04.001.
19. M. J. Powell-Palm, A. Koh-Bell, B. Rubinsky, Isochoric conditions enhance stability of metastable supercooled water. Appl. Phys. Lett 123702. https://doi.org/10.1063/1.5145334 (2020).
20. Perez, A. Pedro, “Thermodynamic and heat transfer analysis for isochoric cryopreservation.” (2006).
21. B. Rubinsky, P. A. Perez, M. E. Carlson, The thermodynamic principles of isochoric cryopreservation. Cryobiology (2005) https:/doi.org/10.1016/j.cryobiol.2004.12.002.
22. A. N. Consiglio, D. Lilley, R. Prasher, B. Rubinsky, M. J. Powell-Palm, Methods to stabilize aqueous supercooling identified by use of an isochoric nucleation detection (INDe) device. Cryobiology (2022) https:/doi.org/10.1016/j.cryobiol.2022.03.003.
23. S.-I. Campean, et al., Analysis of the relative supercooling enhancement of two emerging supercooling techniques. AIP Adv. 11, 055125 (2021).
24. M. J. Powell-Palm, et al., Isochoric supercooled preservation and revival of human cardiac microtissues. Commun. Biol. 4 (2021).
25. Y. Zhang, et al., Isochoric vitrification: An experimental study to establish proof of concept. Cryobiology (2018) https:/doi.org/10.1016/j.cryobiol.2018.06.005.
26. V. Bhagat, M. Becker, Degradable Adhesives for Surgery and Tissue Engineering. Biomacromolecules 18, 3009-3039 (2017).
27. F. Botea, et al., An exploratory study on isochoric supercooling preservation of the pig liver. Biochem. Biophys. Reports 34, 101485 (2023).

I claim:

1. A method for reducing probability of ice nucleation during preservation of biological matter in isochoric systems comprising:
(a) placing biological matter in a flexible and impermeable inner container;
(b) adding to the inner container an inner solution with a melting point that is higher than a desired storage temperature;
(c) removing bulk gas from the inner container;
(d) sealing the inner container;
(e) placing the inner container in a rigid. non-thermally insulating outer container so as to create a space between an outer surface of the inner container and an inner surface of the outer container;
(f) filling the space between the outer surface of the inner container and the inner surface of the outer container with an outer solution;
wherein the biological matter and the inner solution together each has an equilibrium melting point, and the outer solution has a melting point that is lower than the equilibrium melting point of the biological matter and lower than the equilibrium melting point of the inner solution;
(g) removing bulk gas from the outer container;
(h) sealing the outer container;
(i) cooling the inner container, the outer container, the biological matter, the inner solution, and the outer solution to the desired storage temperature;
(j) maintaining the inner container, the outer container, the biological matter, the inner solution, and the outer solution at the desired storage temperature for a desired storage period;
(k) warming the inner container, the outer container, the biological matter, the inner solution, and the outer solution to a temperature that is higher than the desired storage temperature;
(l) unsealing the outer container and the inner container; and
(m) removing the biological matter from the inner container.

2. A method for reducing probability of ice nucleation during preservation of biological matter in isochoric systems comprising:
(a) placing biological matter in a flexible and impermeable inner container;
(b) removing bulk gas from the inner container;
(c) sealing the inner container;
(d) placing the inner container in a rigid, non-thermally insulating outer container so as to create a space between an outer surface of the inner container and an inner surface of the outer container;
(e) filling the space between the outer surface of the inner container and the inner surface of the outer container with an outer solution;
wherein the biological matter has a melting point, and the outer solution has a melting point that is lower than the melting point of the biological matter;
(f) removing bulk gas from the outer container;
(g) sealing the outer container;
(h) cooling the inner container, the outer container, the biological matter, and the outer solution to the desired storage temperature:
(i) maintaining the inner container, the outer container, the biological matter, and the outer solution at the desired storage temperature for a desired storage period;
(j) warming the inner container, the outer container, the biological matter, and the outer solution to a temperature that is higher than the desired storage temperature;
(k) unsealing the outer container and the inner container; and
(l) removing the biological matter from the inner container.

3. The method of claim 1 or 2, wherein the desired storage temperature is at or less than 0° Celsius.

4. The method of claim 1, wherein the desired storage temperature is lower than the equilibrium melting point of the biological matter and lower than the equilibrium melting point of the inner solution; and
wherein the desired storage temperature is higher than the melting point of the outer solution.

5. The method of claim 2, wherein the desired storage temperature is lower than the melting point of the biological matter; and
wherein the desired storage temperature is higher than the melting point of the outer solution.

6. The method of claim 1, wherein the biological matter and the inner solution each has a glass transition temperature;
wherein the outer solution has a glass transition temperature;
wherein the desired storage temperature is below the glass transition temperature of the biological matter and below the glass transition temperature of the inner solution;
wherein the desired storage temperature is below the glass transition temperature of the outer solution; and
wherein the glass transition temperature of the outer solution is higher than the glass transition temperature of the biological matter and higher than the glass transition temperature of the inner solution.

7. The method of claim 2, wherein the biological matter has a glass transition temperature;
wherein the outer solution has a glass transition temperature;
wherein the desired storage temperature is below the glass transition temperature of the biological matter;
wherein the desired storage temperature is below the glass transition temperature of the outer solution; and
wherein the glass transition temperature of the outer solution is higher than the glass transition temperature of the biological matter.

8. The method of claim 1 or 2, wherein the inner container is comprised of a hydrophobic polymeric substance.

9. The method of claim 1, wherein the inner solution is comprised of an aqueous solution containing organic molecules at a first concentration.

10. The method of claim 1, wherein the inner solution is comprised of an aqueous solution containing chemical cryoprotectants at a first concentration.

11. The method of claim 9, wherein the outer solution is comprised of an aqueous solution containing organic molecules at a second concentration; and
wherein the second concentration of organic molecules in the outer solution is higher than the first concentration of organic molecules in the inner solution.

12. The method of claim 10, wherein the outer solution is comprised of an aqueous solution containing chemical cryoprotectants at a second concentration; and
wherein the second concentration of chemical cryoprotectants in the outer solution is higher than the first concentration of organic molecules in the inner solution.

13. The method of claim 1, further comprising the step of perfusing the biological matter with the inner solution.

14. The method of claim 1, wherein the step of cooling the inner container, the outer container, the biological matter, the inner solution, and the outer solution to the desired storage temperature and the step of warming the inner container, the outer container, the biological matter, the inner solution, and the outer solution to a temperature that is higher than the desired storage temperature are both performed at a rate that is within the range of 0.01° C. per minute to 10° C. per minute.

15. The method of claim 1, wherein the step of cooling the inner container, the outer container, the biological matter, the inner solution, and the outer solution to the desired storage temperature and the step of warming the inner container, the outer container, the biological matter, the inner solution, and the outer solution to a temperature that is higher than the desired storage temperature are both performed at a rate that is within the range of 1° C. per minute to 1000° C. per minute.

16. The method of claim 2, wherein the step of cooling the inner container, the outer container, the biological matter, and the outer solution to the desired storage temperature and the step of warming the inner container, the outer container, the biological matter, and the outer solution to a temperature that is higher than the desired storage temperature are both performed at a rate that is within the range of 0.01° C. per minute to 10° C. per minute.

17. The method of claim 2, wherein the step of cooling the inner container, the outer container, the biological matter, and the outer solution to the desired storage temperature and the step of warming the inner container, the outer container, the biological matter, and the outer solution to a temperature that is higher than the desired storage temperature are both performed at a rate that is within the range of 1° C. per minute to 1000° C. per minute.

18. The method of claim 2, wherein the inner container is comprised of a flexible material that is in direct contact with an outer surface of the biological matter and that does not allow transmission of mass.

19. The method of claim 18, wherein the flexible material is a tissue adhesive.

20. An apparatus for reducing probability of ice nucleation during preservation of biological matter in isochoric systems comprising:
(a) an outer container that is rigid and non-thermally insulating;
wherein the outer container comprises a seal that is configured to provide air- and liquid-tight sealing;
(b) an inner container that is situated within the outer container;
wherein the inner container is flexible but cannot transmit mass;
(c) an inner solution within the inner container;
wherein the inner solution has an equilibrium melting point that is above a desired sub-zero centigrade storage temperature; and
(d) an outer solution within the outer container and outside of the inner container;
wherein the outer solution is comprised of a liquid that has an equilibrium melting point that is below the desired sub-zero centigrade storage temperature.

21. An apparatus for reducing probability of ice nucleation during preservation of biological matter in isochoric systems comprising:
(a) an outer container that is rigid and non-thermally insulating;
wherein the outer container comprises a seal that is configured to provide air- and liquid-tight sealing;
(b) an inner container that is situated within the outer container;
wherein the inner container is flexible but cannot transmit mass;
(c) an inner solution within the inner container;
wherein the inner solution has an equilibrium melting point that is above a desired sub-zero centigrade storage temperature; and
(d) an outer solution within the outer container and outside of the inner container;
wherein the outer solution is configured to undergo vitrification at the desired sub-zero centigrade storage temperature.

22. An apparatus for reducing probability of ice nucleation during preservation of biological matter in isochoric systems comprising:
(a) an outer container that is rigid and non-thermally insulating;
wherein the outer container comprises a seal that is configured to provide air- and liquid-tight sealing;
(b) at least two inner containers that are situated within the outer container;
wherein the inner containers are flexible but cannot transmit mass;
(c) an inner solution within each of the inner containers;
wherein the inner solution has an equilibrium melting point that is above a desired sub-zero centigrade storage temperature; and
(d) an outer solution within the outer container and outside of the inner containers;
wherein the outer solution is comprised of a liquid that has an equilibrium melting point that is below the desired sub-zero centigrade storage temperature.

23. An apparatus for reducing probability of ice nucleation during preservation of biological matter in isochoric systems comprising:
(a) an outer container that is rigid and non-thermally insulating;
wherein the outer container comprises a seal that is configured to provide air- and liquid-tight sealing;
(b) at least two inner containers that are situated within the outer container;
wherein the inner containers are flexible but cannot transmit mass;
(c) an inner solution within each of the inner containers;
wherein the inner solution has an equilibrium melting point that is above a desired sub-zero centigrade storage temperature; and
(d) an outer solution within the outer container and outside of the inner containers;
wherein the outer solution is configured to undergo vitrification at the desired sub-zero centigrade storage temperature.

24. The apparatus of claim 20, 21, 22 or 23, further comprising:
(e) a means of providing temperature control to the apparatus;
(f) a means of monitoring temperature of the outer container;
(g) a means of monitoring pressure within the outer container; and
(h) an external processor that is configured to communicate with the means of providing temperature control, the means of monitoring temperature, and the means of monitoring pressure.

25. The apparatus of claim 20, 21, 22 or 23, wherein each of the inner containers is comprised of a low-density polyethylene.

26. The apparatus of claim 20, 21, 22 or 23, wherein the outer container is comprised of a transparent rigid material.

27. The apparatus of claim 20, 21, 22 or 23, further comprising a means for protecting the apparatus from vibration.
